(19) United States
(12) Patent Application Publication
(10) Pub. No.: US 2008/0173496 A1
(43) Pub. Date: Jul. 24, 2008

(54) Method for operating mode-dependent sound control

(76) Inventor: Uwe Kassner, Moeglingen (DE)

Correspondence Address: KENYON & KENYON LLP, ONE BROADWAY, NEW YORK, NY, 10004, US

(21) Appl. No.: 12/005,765

(22) Filed: Dec. 27, 2007

(30) Foreign Application Priority Data
Dec. 27, 2006 (DE) 102006061564.6

(51) Int. Cl. F02B 77/13

(52) U.S. Cl. 181/204

(57) ABSTRACT

A method for sound control in a unit of the engine periphery of an internal combustion engine of a vehicle, in particular in an exhaust system of the internal combustion engine, a sound control signal being generated based on a detected sound emission of the unit and injected into the unit, and the sound control signal is also generated as a function of the operating mode of the internal combustion engine.

### FIELD OF THE INVENTION

The present invention relates to a method for sound control in a unit of the engine periphery of an internal combustion engine of a vehicle, in particular in an exhaust system of the internal combustion engine, based on a detected sound emission of the unit, a sound control signal being generated and injected into the unit. Furthermore, the present invention relates to a sound control device for executing such a method and a computer program having program code for executing all steps of such a method.

### BACKGROUND INFORMATION

It is known from the related art to control undesirable sound signals of the exhaust system of a vehicle having an internal combustion engine by actively controlling the noise using a suitable compensating sound field. For this purpose, a sound control signal is generated in a control circuit as a function of a sound signal recorded via a microphone, the sound control signal in turn being injected into the muffler of the exhaust system via a sound converter. The control circuit contains a controller having parameters which are stored as a function of the operating point. The controller is adapted as a function of, for example, the engine speed, the engine load, and the ignition angle, i.e., operating point-dependent variables, in order to achieve a certain control target, minimum noise generation at the exhaust system, for example. For the design of an appropriate device, reference is made to the publication “Variable Gestaltung des Abgasmündungsgeräuschs am Beispiel eines V6-Motors” (Variable formation of the exhaust discharge noise in a V6 engine as an example), Heil, Enderle, MTZ October 2001, p. 786-794. Moreover, European Patent No. EP 0 840 285 and German Patent Application No. DE 199 49 685 describe devices for sound control in the exhaust system or in the intake system of an internal combustion engine.

It is also known from the related art that internal combustion engines may be operated using different numbers of strokes, a four-stroke operation among other things, the number of strokes having a distinct effect on the noise emitted by the exhaust system of the internal combustion engine. Meanwhile, methods are being proposed in which internal combustion engines may be operated with different numbers of strokes directly one after the other. The known methods and devices for sound control fail in such an operational mode.

### SUMMARY OF THE INVENTION

One object of the present invention is to enable a more comprehensive control of the sound emission by a unit of the engine periphery of an internal combustion engine; an adaptation to different numbers of strokes should be possible in particular. The general object of the present invention is to improve on methods and devices which are known from the related art.

This object is achieved by a method for sound control in a unit of the engine periphery of an internal combustion engine of a vehicle, in particular in an exhaust system of the internal combustion engine and based on a detected sound emission of the unit, a sound control signal being generated and injected into the unit, wherein the sound control signal is also generated as a function of the operating mode of the internal combustion engine. The unit of the internal combustion engine may be the exhaust system of the internal combustion engine or the air intake system of the internal combustion engine. The sound control signal is preferably generated by a controller and is conveyed to a sound converter, e.g., a solenoid loudspeaker or a piezoelectric loudspeaker, and injected into the unit. The sound converter converts the electrical sound control signal into an acoustic signal. On its input side, the controller is preferably connected to a microphone which enables detection of the sound emission of the unit, the microphone being preferably situated in the proximity of the unit.

According to the present invention, the sound control signal is also generated as a function of the operating mode of the internal combustion engine. This has the advantage that the sound control may be adapted to the operating mode of the internal combustion engine so that, also in different operating modes, the noise generation, which is in agreement with statutory provisions or which is formed corresponding to a noise target “noise design,” may be adjusted at the unit of the engine periphery.

The operating mode of the internal combustion engine is preferably the number of strokes of the internal combustion engine, so that the sound control signal is also generated as a function of the number of strokes with which the internal combustion engine is operated. The number of strokes may be, for example, two, four, six, or another number of strokes. The present invention is particularly suitable for an internal combustion engine which may be operated as a two-stroke engine and as a four-stroke engine. The sound control signal is preferably generated as a function of the number of strokes so that a predefined noise design is met. Internal combustion engines which may be operated in different operating modes or numbers of strokes have the advantage that they may be operated differently depending on the power requirements, so that fuel may be possibly saved. The internal combustion engine is preferably operable as a two-stroke engine or as a four-stroke engine or as a six-stroke engine, particular advantages resulting when the internal combustion engine is configured for the purpose of being operated with one of the mentioned numbers of strokes.

The sound control signal is preferably generated so that, when the operating mode of the internal combustion engine changes, the sound emission of the unit remains essentially unchanged. The change in the operating mode is preferably the change between the different numbers of strokes with which the internal combustion engine is operated. This has the advantage that neither the driver nor the surroundings receives unambiguous acoustic information about the change in the operating mode of the internal combustion engine.

A controller is advantageously provided which generates the sound control signal from the detected sound emission, the controller being configured in such a way that its behavior is predefinable by selecting a parameter and the parameter is selected as a function of the operating mode. It is particularly preferred if the controller may be controlled by the selection of a parameter set in such a way that its behavior is predefinable by the selection of the parameter set, the parameter set for the controller being selected as a function of the operating mode. For example, controllers are advantageous which have multiple filters, an individual parameter or a group of parameters being able to be stored in the parameter set for each filter so that the filters are unambiguously controlled by the parameter. This feature has the advantage in general that, in the event of a change in the operating mode or a change in the numbers of strokes with which the internal combustion engine is operated, a rapid switchover is possible so that the sound emission of the unit remains essentially unchanged.

An operating point parameter which is dependent on the operating point of the internal combustion engine is advantageously taken into account during generation of the sound control signal. This operating point parameter may be the speed of the internal combustion engine or the throttle position of the internal combustion engine. This has the advantage that the sound control signal may be better adapted to the operation of the internal combustion engine.

Taking an additional parameter into account during generation of the sound control signal also yields advantages, the additional parameter being independent of the operating point and the operating mode of the internal combustion engine. The operating point parameter or the additional parameter is advantageously used as a setpoint for the controller, so that the behavior of the controller is predefinable due to the selection of the operating point parameter or the additional parameter. The additional parameter may express the behavior or the preferences of the driver, for example. The advantage is that it is possible in this way to adapt the sound emitted by the unit of the engine periphery to the preferences of the driver.

Instead of the above-mentioned parameter sets, preferably two parameter sets for the two-stroke operation and the four-stroke operation, different control algorithms may also be used which are switched, so that the sound of the unit does not change when the operating mode is switched. The unit is preferably a muffler of the exhaust system of the internal combustion engine or the intake system of the internal combustion engine. Controlling the sound emitted by these two units yields the advantage that two main sound sources of a vehicle, in which the internal combustion engine is installed, are controlled, so that the noise emitted by the vehicle may be significantly controlled. Therefore, controlling both mentioned units yields particular advantages. However, controlling only one unit is alternatively advantageous, e.g., for avoiding unnecessary costs, if control of the sound emitted by the intake system can be omitted since it plays only a secondary role compared to the sound emitted by the muffler. However, controlling only the sound emitted by the intake system may conversely also be advantageous if the sound emitted by the intake system is dominating within the total sound emission from the engine periphery, for example.

A further subject matter of the present invention is a sound control device designed for executing a method according to the present invention having possibly one or multiple of the above-mentioned advantageous features.

A computer program which includes program codes for executing all steps according to one of the advantageous methods presented above when the program is run on a computer is also a subject matter of the present invention.

### BRIEF DESCRIPTION OF THE DRAWINGS

FIG. 1 shows a sound control device according to the present invention.

FIG. 2 shows a method according to the present invention which is executed using the sound control device of FIG. 1.

### DETAILED DESCRIPTION

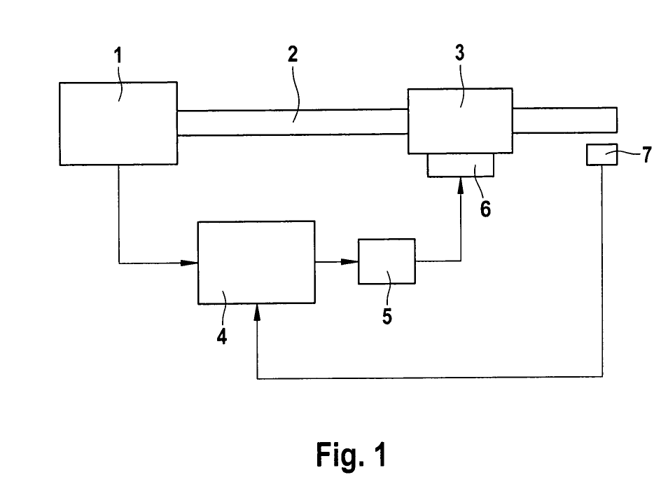

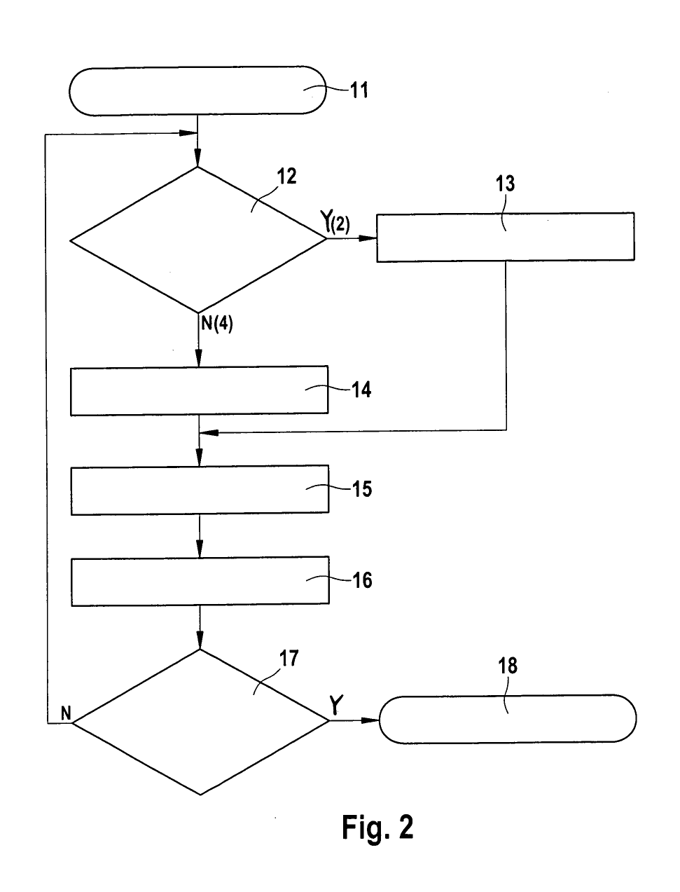

FIG. 1 shows a sound control device according to the present invention which is provided for controlling the sound which is emitted by a muffler 3. Muffler 3 is connected to an internal combustion engine 1 of a vehicle via a pipe 2. For controlling the sound emitted by muffler 3, a controller 4 is provided, which generates a sound control signal, with which an amplifier 5 is activated which in turn activates a sound converter 6 which is situated on muffler 3 and designed to inject the amplified sound control signal into muffler 3 in such a way that sound emitted by muffler 3 is appropriately controlled. Moreover, controller 4 is connected to a microphone 7 which picks up the sound emitted by muffler 3, in this case the sound at a muzzle pipe of an exhaust system composed of pipe 2 and muffler 3. Furthermore, controller 4 is connected to internal combustion engine 1 or a control device of internal combustion engine 1 in such a way that controller 4 receives information about the operating mode and the operating point of the internal combustion engine. The operation of the sound control device shown in FIG. 1 is explained in greater detail in the following in connection with FIG. 2 based on a preferred exemplary embodiment of a method according to the present invention. In the description of FIG. 2, reference is made to FIG. 1.

FIG. 2 shows a method according to the present invention for controlling the sound which is emitted by muffler 3 as a unit of the engine periphery. The method begins in a step 11 with the start of internal combustion engine 1 of the vehicle. A query is subsequently made in a step 12 regarding in which operating mode internal combustion engine 1 is operated. The concrete query regards whether the internal combustion engine is operated as a two-stroke engine. If this is the case, the method is continued in a step 13. The other possible operating mode of internal combustion engine 1 is as a four-stroke engine, so that, in the event of a negative response to the query of step 12, it is assumed that internal combustion engine 1 is operated as a four-stroke engine. In this case, the method jumps to a step 14. The parameter set stored for the respective stroke number is called in steps 13 and 14. These parameter sets are used to activate controller 4 using the appropriate parameter set, so that, via sound converter 6, controller 4 controls the sound emitted by muffler 3 according to the parameter sets. Both parameter sets are adjusted to one another in such a way that the emitted sound does not show any substantial differences after control by the sound control signal, regardless of whether the internal combustion engine is operated as a two-stroke engine or as a four-stroke engine. After selection of one of the two parameter sets in steps 13 and 14, the method continues in any case with a step 15 in which additional parameters are supplied to controller 4, e.g., the angle position of internal combustion engine 1, so that controller 4 receives information about the pulsation behavior of the exhaust gas in pipe 2 and muffler 3. Furthermore, additional operating point-dependent parameters or operating point-independent parameters are supplied to controller 4 in step 15 if needed. For example, information about silencers preferred by the driver may be supplied to controller 4.

Controller 4 controls the sound in a subsequent step 16. This control is continued, a query being made in a subsequent step 17 as to whether the internal combustion engine is shut off. If the internal combustion engine is shut off, then the method jumps to a step 18 where it is terminated. However, if the internal combustion engine is recognized as still running in step 17, the method jumps back to step 12 in which another query is made as to whether the operating mode of the internal combustion engine has changed. The described circuit is subsequently run through until it is established in step 17 that the internal combustion engine is shut off.

The method is described here in connection with an internal combustion engine which is designed to be operated as a two-stroke engine or as a four-stroke engine. However, it is alternatively also conceivable to use the method with other numbers of strokes, for example in an internal combustion engine which is designed to be operated as a six-stroke engine.

In the represented exemplary embodiment, the sound control device is situated on center muffler 2 and end muffler 3 which form a unit of the engine periphery of internal combustion engine 1, i.e., the exhaust system of internal combustion engine 1. However, the present invention may also be used on other units of the engine periphery, such as the air intake system of internal combustion engine 1.

What is claimed is:

1. A method for sound control in a unit of an engine periphery of an internal combustion engine of a vehicle, comprising:
generating a sound control signal as a function of a detected sound emission of the unit and an operating mode of the internal combustion engine; and
injecting the sound control signal into the unit.

2. The method according to claim 1, wherein the unit is in an exhaust system of the engine.

3. The method according to claim 1, wherein the operating mode of the internal combustion engine is a number of strokes of the internal combustion engine, so that the sound control signal is also generated as a function of a number of strokes with which the internal combustion engine is operated.

4. The method according to claim 1, wherein the internal combustion engine is operable as one of a two-stroke engine, a four-stroke engine and a six-stroke engine.

5. The method according to claim 1, wherein the sound control signal is generated so that the sound emission of the unit remains substantially unchanged when the operating mode of the internal combustion engine changes.

6. The method according to claim 1, wherein the sound control signal is generated by a controller whose behavior is predefinable by selecting a parameter and the parameter for the controller is selected as a function of the operating mode.

7. The method according to claim 1, wherein, during generation of the sound control signal, an operating point parameter, which is dependent on an operating point of the internal combustion engine, is also taken into account.

8. The method according to claim 1, wherein, during generation of the sound control signal, an additional parameter, which is independent of an operating point and the operating mode of the internal combustion engine, is also taken into account.

9. The method according to claim 1, wherein the unit is a muffler of an exhaust system of the internal combustion engine.

10. The method according to claim 1, wherein the unit is an intake system of the internal combustion engine.

11. A sound control device for sound control in a unit of an engine periphery of an internal combustion engine of a vehicle, comprising:
means for generating a sound control signal as a function of a detected sound emission of the unit and an operating mode of the internal combustion engine; and
means for injecting the sound control signal into the unit.

12. A computer-readable medium containing a computer program which when executed by a processor performs the following method for sound control in a unit of an engine periphery of an internal combustion engine of a vehicle, comprising:
generating a sound control signal as a function of a detected sound emission of the unit and an operating mode of the internal combustion engine; and
injecting the sound control signal into the unit.
